(19) United States
(12) Patent Application Publication
(10) Pub. No.: US 2012/0186173 A1
(43) Pub. Date: Jul. 26, 2012

(54) SAFETY CAP ASSEMBLY AND METHODS OF USE THEREOF

(76) Inventor: Joseph J. Daniels, Roslyn Heights, NY (US)

(21) Appl. No.: 13/359,172

(22) Filed: Jan. 26, 2012

Related U.S. Application Data
(60) Provisional application No. 61/436,529, filed on Jan. 26, 2011.

(51) Int. Cl. E06B 3/58; B23P 11/00

(52) U.S. Cl. 52/204.62; 29/428

(57) ABSTRACT

A safety cap assembly for use with a coupler for a point glass structure is disclosed. In exemplary embodiments, the safety cap assembly may include a base having a top edge portion defining a top aperture; a bottom edge portion defining a bottom aperture; a wall extending from the top edge portion to the bottom edge portion; a channel extending from the top aperture to the bottom aperture, the channel adapted to receive at least a first portion of the coupler and to receive filler material that provides support to the point glass structure; and a cover disposed on the top edge portion of the base, the cover having a top surface having an aperture formed therein adapted to receive at least a second portion of the coupler.

### RELATED APPLICATIONS

This application is a non-provisional application based on U.S. Provisional Application Ser. No. 61/436,529, filed Jan. 26, 2011, the contents of which are incorporated herein by reference in their entirety as if fully set forth herein.

### FIELD OF THE INVENTION

The present disclosure generally relates to apparatus and methods for securing point fix glass structures.

### SUMMARY OF THE INVENTION

The present disclosure generally relates to a safety cap assembly that can be used with point fix glass structures. In exemplary embodiments, the safety cap assembly for use with a coupler for a point glass structure may include a base having a top edge portion defining a top aperture; a bottom edge portion defining a bottom aperture; a wall extending from the top edge portion to the bottom edge portion; a channel extending from the top aperture to the bottom aperture, the channel adapted to receive at least a first portion of the coupler and to receive filler material that provides support to the point glass structure; and a cover disposed on the top edge portion of the base, the cover comprising a top surface having an aperture formed therein adapted to receive at least a second portion of the coupler.

In exemplary embodiments, the top surface may include an outer perimeter larger than the outer perimeter of the top aperture of the base. In exemplary embodiments, the aperture of the cover may be smaller than the top aperture of the base. In exemplary embodiments, the bottom aperture of the base may be larger than the top aperture of the base. In exemplary embodiments, the base may include at least one tiered edge formed in the wall substantially between the top edge portion and the bottom edge portion. In exemplary embodiments, at least one of the cover and the base may be ring-shaped.

In exemplary embodiments, the cover further may include a lip extending perpendicularly from the top surface adjacent the perimeter of the top surface, the lip adapted to fit over the wall adjacent the top edge portion of the base. In exemplary embodiments, at least one of the cover and the base may include a material adapted to be cut. In exemplary embodiments, the base may include a cut area extending from the bottom edge portion to the top edge portion, the cut area adapted to allow the base to be placed about the first portion of the coupler.

In exemplary embodiments, the cover may include a cut area extending from an outer edge of the top surface to the aperture adapted to allow the cover to be placed about the second portion of the coupler. In exemplary embodiments, the base may include a perforated portion extending from the bottom edge portion to the top edge portion; and the perforated portion may be adapted to be torn, thereby allowing the base to be placed around the first portion of the coupler.

In exemplary embodiments, the cover may include a perforated portion extending from an outer edge of the top surface to the aperture; and the perforated portion may be adapted to be torn, thereby allowing the cover to be placed around the second portion of the coupler. In exemplary embodiments, the cap assembly may further comprise one or more geometric protrusions extending through the top surface of the cover into the channel. In exemplary embodiments, each of the one or more geometric protrusions may be a screw. In exemplary embodiments, the wall may include a hinged portion and connector portion, the connector portion may include a male connector and a female connector adapted to releasably attach; and the hinged portion may be adapted to allow at least two portions of the base to hinge about the hinged portion when the connector portion may be unattached, thereby allowing the base to be placed around the first portion of the coupler and attached around the first portion with the connector portion.

In exemplary embodiments, the cover and the base may be opaque. In exemplary embodiments, the cover and the base may be translucent. In exemplary embodiments a safety cap assembly may include a base comprising a top edge portion defining a top aperture; a bottom edge portion defining a bottom aperture; a wall extending from the top edge portion to the bottom edge portion; a channel extending from the top aperture to the bottom aperture, the channel adapted to receive at least a first portion of the coupler; a filler material disposed inside the channel; and a cover disposed on the top edge portion of the base, the cover comprising a top surface having an aperture formed therein adapted to receive at least a second portion of the coupler.

In exemplary embodiments, the bottom edge portion of the base may be in contact with at least a portion of a glass panel. In exemplary embodiments, the bottom edge portion of the base may be in contact with a film coating a surface of at least a portion of a glass panel. In exemplary embodiments, the filler material may include at least one of an epoxy or a resin. In exemplary embodiments, the first portion of the coupler may be disposed within the channel, the second portion of the coupler may be disposed within the aperture of the cover, and filler material may be in contact with an inner surface of the cover, an inner surface of the base, an outer surface of the first portion of the coupler, and at least a portion of a glass panel.

In exemplary embodiments, the first portion of the coupler may be disposed within the channel; the second portion of the coupler may be disposed within the aperture of the cover; and the filler material may be in contact with an inner surface of the cover, an inner surface of the base, an outer surface of the first portion of the coupler, and a film coating the surface of at least a portion of a glass panel. In exemplary embodiments, the cap assembly may further comprise or more geometric protrusions extending through the top surface of the cover into the channel. In exemplary embodiments, each of the one or more geometric protrusions may be a screw. In exemplary embodiments, the wall may include a hinged portion and connector portion, the connector portion may include a male connector and a female connector adapted to releasably attach; and the hinged portion may be adapted to allow at least two portions of the base to hinge about the hinged portion when the connector portion may be unattached, thereby allowing the base to be placed around the first portion of the coupler and attached around the first portion with the connector portion.

In exemplary embodiments, a method of securing a coupler for a point glass structure is provided that may comprise providing a safety cap assembly comprising a base comprising: a top edge portion defining a top aperture; a bottom edge portion defining a bottom aperture; a wall extending from the top edge portion to the bottom edge portion; a channel extending from the top aperture to the bottom aperture, the channel adapted to receive at least a first portion of the coupler; and a cover comprising a top surface having an aperture formed therein adapted to receive at least a second portion of the coupler; placing the base about the first portion of the coupler; attaching the bottom edge portion to at least a portion of a glass panel; substantially filling the channel with a filler; placing the cover about the second portion of the coupler; and attaching the cover to the top edge portion of the base.

In exemplary embodiments a method of securing a coupler for a point glass structure is provided that may comprise: providing a safety cap assembly comprising: a base comprising: a top edge portion defining a top aperture; a bottom edge portion defining a bottom aperture; a wall extending from the top edge portion to the bottom edge portion; a channel extending from the top aperture to the bottom aperture, the channel adapted to receive at least a first portion of the coupler; at least one of a cut, weakened, or perforated portion extending from the top edge portion to the bottom edge portion on the wall; and a cover comprising: a top surface having an aperture formed therein adapted to receive at least a second portion of the coupler; and at least one of a cut, weakened, or perforated portion extending from an outer surface of the top surface to the aperture formed therein; placing the base about the first portion of the coupler; attaching the bottom edge portion to at least a portion of a glass panel; substantially filling the channel with a filler; placing the cover about the second portion of the coupler; and attaching the cover to the top edge portion of the base.

These and other features of this disclosure are described in, or are apparent from, the following detailed description of various exemplary embodiments of this disclosure.

### BRIEF DESCRIPTION OF THE DRAWINGS

The features and advantages of embodiments of the present invention will be more fully understood with reference to the following, detailed description when taken in conjunction with the accompanying figures, wherein:

FIG. 1 is a perspective view of a safety cap assembly, a coupler, and a glass panel in accordance with exemplary embodiments;

FIG. 2, is a top view of a point-fixed glass structure and safety cap assemblies, in accordance with exemplary embodiments;

FIG. 3 is a side view of a safety cap assembly, a coupler, a surface film, and a glass panel in accordance with exemplary embodiments;

FIG. 4 is an exploded view of elements of a safety cap assembly in accordance with exemplary embodiments;

FIG. 5 is a side view of a safety cap assembly in accordance with exemplary embodiments;

FIGS. 6A-6B are side views of a connector for a safety cap assembly in open and closed configurations, in accordance with exemplary embodiments;

FIG. 7 is a cross-sectional view of a safety cap assembly in accordance with exemplary embodiments;

FIG. 8 is a block flow diagram illustrating an exemplary flow for installing a safety cap assembly in accordance with exemplary embodiments; and

FIG. 9 is a block flow diagram illustrating an exemplary flow for installing a safety cap assembly in accordance with exemplary embodiments.

The headings used herein are for organizational purposes only and are not meant to be used to limit the scope of the description. As used throughout this application, the words “may” and “can” are used in a permissive sense (i.e., meaning having the potential to), rather than the mandatory sense (i.e., meaning must). Similarly, the words “include,” “including,” and “includes” can mean including but not limited to. To facilitate understanding, like reference numerals have been used, where possible, to designate like elements common to the figures.

### DETAILED DESCRIPTION

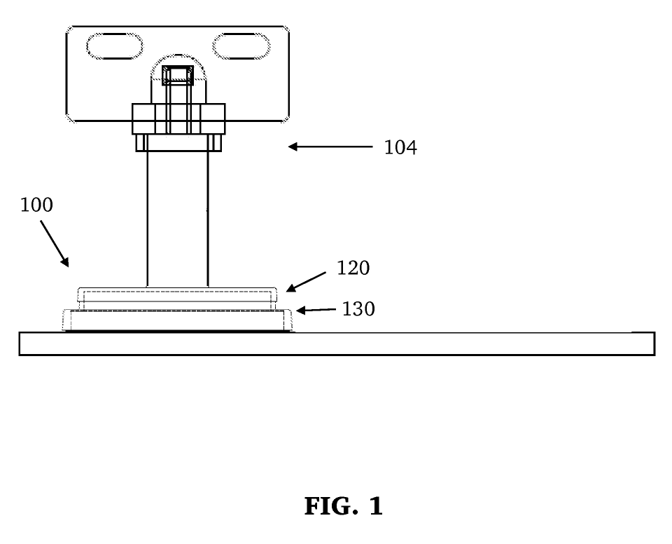

Exemplary embodiments of the present invention generally relate to a safety cap assembly that can be used with point-fixed glass structures. The following detailed description generally describes various exemplary embodiments of the present disclosure, as depicted in FIGS. 1-9, and should not be considered limiting to other equally effective embodiments, as understood to those of ordinary skill in the art.

In the following detailed description, numerous specific details are set forth in order to provide a thorough understanding of embodiments or other examples described herein. In some instances, well-known methods, procedures, and components have not been described in detail, so as to not obscure the following description. Further, the examples disclosed are for exemplary purposes only and other examples may be employed in lieu of, or in combination with, the examples disclosed.

It will be understood that term “failure” and/or “fail” can be any form of failure such as, but not limited to buckling, corrosion, creep, fatigue, fracture, impact, mechanical overload, rupture, thermal shock, wear, yielding, and/or any other form of failure that can occur with point-fixed glass structures. For ease, only failure due to inclusions, such as, but not limited to Nickel sulphide inclusion is at times described. This is merely for ease and is in no way meant to be a limitation.

FIG. 1 is a perspective view of a safety cap assembly 100, a coupler 104, and a glass panel 102 for use in a point-fixed glass structure in accordance with exemplary embodiments. In exemplary embodiments, the safety cap assembly 100 may include a cover 120 and a base 130. Many curtain walls in buildings use point-fixed glass structures. Point-fixed glass structures can be constructed of any number of glass panels 102 coupled together by at least one coupler 104. Often times, the underlying glass panels 102 may have inclusions which may pose a substantial risk of spontaneous failure, including the shattering of glass. In exemplary embodiments, the use of the safety cap assembly 100 may substantially reduce and/or minimize the risk of damage or injury from such spontaneous failures by adding support to the coupler 104.

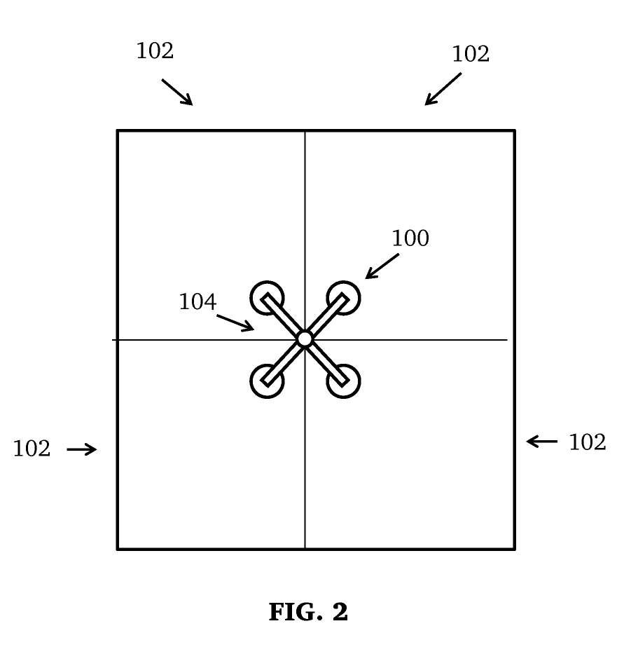

Referring now to FIG. 2, a coupler 104 is shown connecting four glass panels 102. In standard point fixed glass structures, a coupler 104 may support a number of glass panels at a point on each glass panel 102. However, when underlying inclusions in the glass panels 102 cause the window to fail, the coupler 104 may not adequately prevent the risk of injury or property damage that may be caused when the glass panels 102 separate from the coupler 104. As such, in exemplary embodiments, a safety cap assembly 100 may be used to further support the connection between the coupler 104 and the glass panel 102.

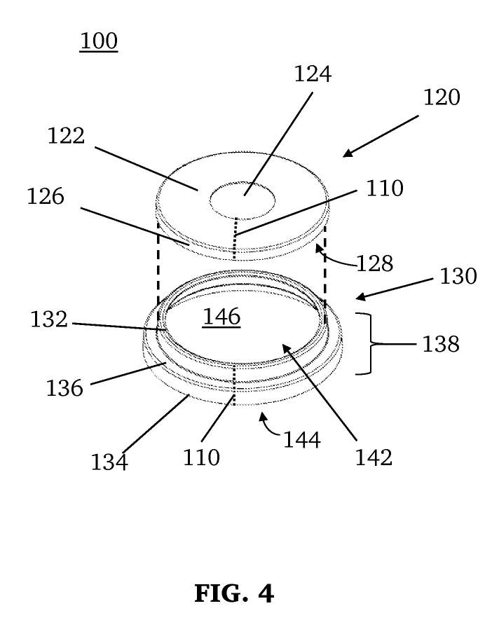

While four glass panels 102, four safety cap assemblies 100, and a single coupler 104 are depicted in FIG. 4, exemplary embodiments of the present invention are not limited to four glass panels 102, four safety cap assemblies 100, and/or a single coupler 104. Rather, this illustration is merely for ease and is in no way meant to be a limitation. For example, coupler 104 can be connected to any number of glass panels 102 and safety cap assemblies 100, consistent with any desirable aesthetics.

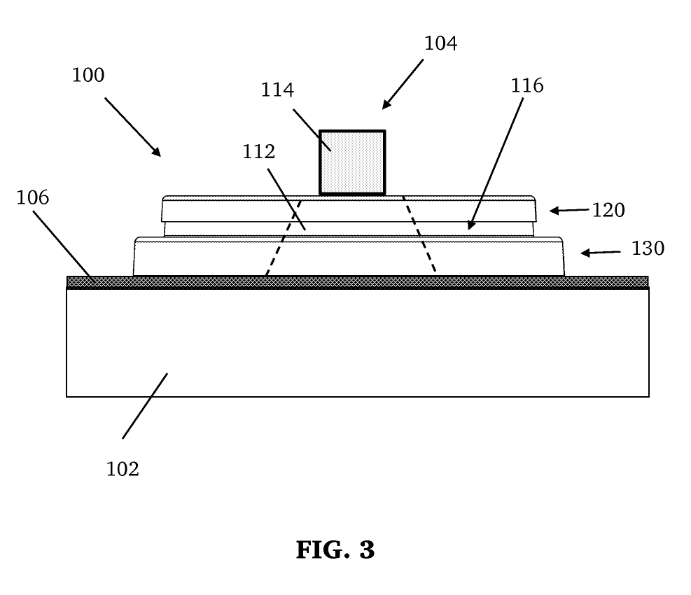

FIG. 3 is a side view of a safety cap assembly 100, a coupler 104, a surface film 106, and a glass panel 102 in accordance with exemplary embodiments. To address the inclusions and the associated risk of failure, a surface film 106 may be applied to glass panels 102 and/or to coupler 104. However, in exemplary embodiments, the use of a safety cap assembly 100 at the interface of the coupler 104 and glass panels 102 and/or film 106 may add additional support and/or reinforcement, thereby reducing and/or minimizing the risk of damage from the failure of one or more glass panels 102.

In exemplary embodiments, to substantially ensure that coupler 104 and an associated glass panel 102 remain coupled and/or if glass panel 102 fails that it will remain coupled to the coupler 104, a safety cap assembly 100 may be used. The safety cap assembly 100 can be constructed such that it can surround at least a portion of coupler 104 and contact at least a portion of the glass panel 102 and/or film 106. In exemplary embodiments, the safety cap assembly 100 may include a cover 120 and a base 130. The coupler 104 may include a first portion 112 and a second portion 114. By way of example, the first portion 112 may be a base or bottom portion of the coupler 104 and the second portion 114 may be an arm portion of the coupler. The coupler may include any number of arms and/or bases adapted to secure a number of glass panels. In exemplary embodiments, the first portion 112 and the second portion 114 may have different dimensions, as depicted in FIG. 3. By way of example, the first portion 112 may include a base having a square, rectangle, cylindrical, pyramid, or cone shape, to name a few. By way of example, the second portion 114 may include an arm having a square, rectangle, cylindrical, pyramid, or cone shape, to name a few. In exemplary embodiments, the first portion 112 and the second portion 114 may also have the same dimensions, thereby forming a single substantially uniform portion of the coupler 104.

With Reference to FIGS. 3-4, in exemplary embodiments, the safety cap assembly 100 can include a cover 120 and a base 130. The cover 120 may include a top surface 122, an aperture 124, a lip 126, a bottom portion 128, and/or a cut area 110. In exemplary embodiments, the base 130 may include an top edge portion 132 defining a top aperture 142, a bottom edge portion 134 defining a bottom aperture 144, a wall 138 extending between the top edge portion 132 and the bottom edge portion 144, a tiered edge 136, and/or a cut area 110. In exemplary embodiments, a channel 146 may extend from the top aperture 142 to the bottom aperture 144 of the base 130. While depicted in FIGS. 3-4 as two separate pieces, it is contemplated that the cover 120 and the base 130 may be a single unitary piece, that is either joined at a point or molded and formed as one piece.

In exemplary embodiments, the cover 120 may be ring-shaped with the aperture 124 disposed in the center of the ring. The cover 120 may have a shape adapted to support at least a portion of the coupler 104, for example, a square, rectangle, triangle, oval, to name a few. The top surface 122 may have a thickness adapted to contain a filler material 116, such as an epoxy or resin. By way of example, the thickness of the top surface 122 may be 0.015-0.050 inches. In exemplary embodiments, the diameter of the cover 120 may be any length adapted to cover the top aperture 142 of the base 130. By way of example, the diameter of the cover 120 may be 1-6 inches.

In exemplary embodiments, the diameter of the aperture 124 in the cover 120 may be any length adapted to accept at least a portion of the coupler 104. By way of example, the diameter of the aperture 124 of the cover 120 may be 0.5-3 inches. In exemplary embodiments, the aperture 124 of the cover 120 may be substantially smaller than the top aperture 142 of the base 130. In exemplary embodiments, the perimeter of the aperture 124 of the cover may be substantially similar to the outer perimeter of at least a portion of the coupler 104, for example, the second portion 114.

In exemplary embodiments, the aperture 124 in the cover 120 may be any shape adapted to receive at least a portion of the coupler 104. For example, the aperture may be a circular shape adapted to receive a second portion 114 of the coupler 104, such as an arm portion. In exemplary embodiments, the aperture 124 may be disposed in any location on the cover 120. Any number of apertures 124 adapted to accept portions of a coupler 104 are contemplated by and within exemplary embodiments. In exemplary embodiments, the cover 120 may be disposed on the top edge portion 132 of the base 130.

In exemplary embodiments, the cover 120 and/or base 130 may include any material adapted to contain a filler material 116. In exemplary embodiments, the filler material 116 may be disposed within the interior surface of the cover 120 and the base 130. For example, the cover 120 and/or base 130 may include any reasonable material such as, but not limited to, any plastic, polyethylene, polyester, aramid, para-aramid, acrylic, nylon, olefin, polyolefin, ultra-high-molecular-weight polyethylene (UHMWPE), high-modulus polyethylene (HMPE), high-performance polyethylene (HPPE), silicon carbide ceramic, thermoset liquid crystalline polyoxazole, lurex, wool, silk, cotton, flax, jute, hemp, modal, bamboo, asbestos, basalt, glass, any combination or further separation thereof, and/or from any material from an animal source, plant source, mineral source, and synthetic source, and/or any other reasonable source and/or limited to any metal and/or alloy such as, but not limited to, aluminum, iron, steel, stainless steel, carbon steel, titanium, iron, copper, zinc, and nickel, to name a few; any plastic material such as, but not limited to, thermoplastics, thermosetting polymers, polyethylene thermoplastics, High-density polyethylene (HDPE), Low-density polyethylene (LDPE), Ultra-high-molecular-weight polyethylene (UHMWPE), Nylon, Rubber, Polypropylene (PP), Polystyrene (PS), High impact polystyrene (HIPS), Acrylonitrile butadiene styrene (ABS), Polyethylene terephthalate (PET), and Polyvinyl chloride (PVC), to name a few; any ceramic such as, but not limited to, alumina and boron carbide, to name a few; any combination and separation thereof; and/or any other material adapted to contain a filler material 116, and/or at least a portion of a coupler 104.

In exemplary embodiments, the cover 120 may include a lip 126. The lip 126 may extend perpendicularly from the top surface 122 adjacent the perimeter of the top surface. The lip 126 may be adapted to fit over the wall 138 adjacent the top edge portion 132 of the base 130. In exemplary embodiments, the lip 126 may have any thickness adapted to laterally secure the cover 120 in position on top of the base 130. By way of example, the lip 126 may have a thickness of 0.1-0.5 inches. In exemplary embodiments, the thickness of the lip 126 may be the same as the thickness of the top surface 122, or it may be a different thickness adapted to laterally secure the cover 120 in position on the top of the base 130.

In exemplary embodiments, the cover 120 may include a bottom portion 128. The bottom portion 128 may include at least one of a bottom edge of the lip 126 and/or at least a portion of an interior surface of the top surface 122. In exemplary embodiments, the bottom portion 128 may be adapted to fit on top of and/or connect with, the top edge portion 132 of the base 130. By way of example, the bottom portion 128 of the cover 120 may connect to the top edge portion 132 of the base 130 by use of adhesives, clips, staples, and/or the frictional fitting, to name a few.

In exemplary embodiments, the base 130 may be ring-shaped or be any shape adapted to support at least a portion of the coupler 104. For example, the base 130 may be a square, rectangle, pyramid, cone, cylinder, triangle, oval, to name a few. In exemplary embodiments, the wall 138 may have a thickness adapted to contain a filler material 116, such as an epoxy or resin, in place. By 5 way of example, the thickness of the wall may be 0.015-0.050 inches. In exemplary embodiments, the base 130 may include a tiered edge 136. Although one tiered edge 136 is depicted in FIG. 4, any number of tiered edges adapted to contain a filler 116 and/or support a coupler 104 is contemplated by and within exemplary embodiments. By way of example, the wall 138 may have 2, 3, 4, 5, or 6 tiered edges, to name a few. In exemplary embodiments, the wall 138 may be any shape adapted to contain and/or support at least a portion of the coupler 104 and/or the filler material 116 within the inner surface of the wall. By way of example the wall 138 may be straight, tiered, jagged, or curved, to name a few. The inclusion of tiered edges 136 may create two or more disc-shaped cavities within the channel 146.

In exemplary embodiments, the height of the wall 138 between the tiered edge 136 and the top edge portion 132 may be any height adapted to support a coupler 104 and/or filler material 116 within the channel 146. By way of example, the height of the wall 138 between the tiered edge 136 and the top edge portion 132 and/or the bottom edge portion 134 may be 0.1-0.7 inches. The height of the wall 138 between the tiered edge 136 and the bottom edge portion 134 may be any height adapted to support a coupler and/or filler material 116 within the channel 146. By way of example, the height of the wall 138 between the tiered edge 136 and the bottom edge portion 134 may be 0.1-0.7 inches.

In exemplary embodiments the height of the wall 138 between the top edge portion 132 and the bottom edge portion 134 may have any height adapted to support a coupler 104 within the channel 146. By way of example, the height of the wall 138 between the top edge portion 132 and the bottom edge portion 134 may be 0.3-1.3 inches. In exemplary embodiments, the interior perimeter of the top edge portion 132 may include an inner lip substantially extending into the channel 146. By way of example, the height of the inner lip may be 0.01-0.12 inches.

In exemplary embodiments, the top edge portion 132 may have an inner perimeter and an outer perimeter. In exemplary embodiments, the width between the inner perimeter and the outer perimeter of the top edge portion 132 may have a width adapted to support the top surface 122. For example, the width between the inner perimeter and the outer perimeter of the top edge portion 132 may be 0.05-0.26 inches. In exemplary embodiments, the inner perimeter of the top edge portion 132 may define a top aperture 142.

In exemplary embodiments, the top aperture 142 may have a diameter adapted to accept at least a portion of the coupler 104 and/or the filler material 116. By way of example, the top aperture 142 may have a diameter of 1-6 inches. In exemplary embodiments, the top aperture 142 may be larger than the aperture 124 of the cover 120. Although the top aperture 142 is depicted in a circular shape, other shapes adapted to receive at least a portion of the coupler 104 are contemplated by and within exemplary embodiments. By way of example, the top aperture 142 may be a square, rectangle, triangle, oval, to name a few. In exemplary embodiments, the top surface 122 may have an outer perimeter that is greater than the perimeter of the top aperture 142 of the base 130.

In exemplary embodiments, the bottom edge portion 134 may have a diameter adapted to secure the coupler 104 to a glass panel 102 and/or film 106. In exemplary embodiments, the perimeter of the bottom edge portion 134 may define a bottom aperture 144. In exemplary embodiments, the bottom aperture 144 may have a diameter adapted to accept at least a portion of the coupler 104 and/or the filler material 116. By way of example, the bottom aperture 144 may have a diameter of 1-7 inches. In exemplary embodiments, the bottom aperture 144 may be larger than the top aperture 142 of the base and/or the aperture 124 of the cover 120. Although the bottom aperture 144 is depicted in a circular shape, other shapes adapted to receive at least a portion of the coupler 104 are contemplated by and within exemplary embodiments. By way of example, the bottom aperture 144 may be a square, rectangle, triangle, oval, to name a few.

The top edge portion 132 of the base 130 may define a top aperture 142 and the bottom edge portion 134 may define a bottom aperture 144. The channel 146 may extend between the top aperture 142 and the bottom aperture 144. In exemplary embodiments, the channel 146 may have a size adapted to receive at least a portion of the coupler 104 and/or a filler material 116. In exemplary embodiments, the channel 146 may have a size adapted to receive at least a first portion 112 of the coupler 104, for example the base portion of the coupler 104, and/or a filler material 116. In exemplary embodiments, the top edge portion 132 may have a lip adapted to receive at least a portion of the cover 120. In exemplary embodiments, the top edge portion 132 may be any shape adapted to receive the cover 120.

In exemplary embodiments, the cover 120 and/or the base 130 may be a material adapted to be cut along a cut area 110. As used herein the term “cut area” reflects an area that may be cut using a cutting process. In exemplary embodiments, the cut area 110 may be pre-cut or may be adapted to be cut. By way of example, the cut area 110 may include a material capable of being cut, the cut area 110 may be a weakened portion, and/or the cut area 110 may be a perforated portion, to name a few. For example, the cover 120 and/or the base 130 may be plastic. In exemplary embodiments, the cut area 110 may be a perforated portion extending from the bottom edge portion 134 of the base 130 to the top edge portion 132 of the base 130 adapted to be torn, thereby allowing the base 130 to be placed around at least a portion of the coupler 104 such that the portion of the coupler 104 is disposed in the channel 146 and the wall 138 surrounds the portion of coupler 104.

In exemplary embodiments, when the cut area 110 may include a perforated portion extending from an outer edge of the top surface 122 to the aperture 124 of the cover 120, the perforated portion along the cut area 110 may be adapted to be torn, thereby allowing the cover 120 to be placed around at least a portion of the coupler 104 such that the portion of the coupler 104 is disposed in the aperture 124 and the top surface 122 surrounds the portion of the coupler 104.

In exemplary embodiments, the safety cap assembly 100 may have any feasible level of translucency. For example the safety cap assembly 100 may be 100% opaque, 100% translucent, or any translucency level therebetween. The safety cap assembly 100 may also be different colors, textures, or shapes for aesthetic value.

In exemplary embodiments, when the cover 120 is placed on the base 130 and the bottom edge portion 134 of the base 130 is in contact with the glass panel 102 and/or the film 106, the channel 146 may be substantially enclosed by the inside of the cover 120, the inside of the base 130, and the glass panel 102 and/or film 106, creating a substantially enclosed space adapted for containing at least a portion of the coupler 104 and/or the filler 116. For example, the substantially enclosed space may be adapted to receive the second portion 114 and/or the filler material 116. The filler material 116 may fill in the remaining space of this enclosed space that is not occupied by the coupler 104 when the cap assembly 100 is placed around the coupler 104.

In exemplary embodiments, the filler material 116 may fill a portion or all of this remaining space. By way of example, the filler material may fill 100%, 75%, 50%, or 25% of the remaining space, to name a few. In exemplary embodiments, the filler material 116 may comprise a material adapted to secure the coupler 104 to the glass panel 102 and/or film 106. The filler material 116 may also penetrate and support one or more voids formed in the glass panel 106 around, adjacent to, and/or juxtapose the first portion 112 of the coupler 104. By way of example, the filler material 116 may include an epoxy, resin, adhesive, foam, to name a few. In exemplary embodiments, if the cap assembly 100 is removed after the filler material 116 hardens, the filler material 116 may be adapted to secure the coupler 104 to the glass panel 102 and/or film 106 by itself. In exemplary embodiments, the cap assembly 100 may also comprise a sufficiently rigid material such that a filler material 116 is not required to secure the coupler 104 to the glass panel 102 and/or film 106. For example, the cap assembly 100 may be secured to the glass panel 102 and/or film 106 with an adhesive or other securing means, and the cover 120 may be secured to the base 130 with an adhesive or other securing means. The cover 120 may be secured to the base 130 by the filler material 116 itself, or with an additional securing member, such as an adhesive. The cover 120 may also be secured to the base 130 with other means, for example, by frictional fitting. In exemplary embodiments, filler material 116 may be integral with the safety cap assembly 100 including the cover 120 and/or the base 130. In exemplary embodiments, the filler material 116 may be separate from the safety cap assembly 100.

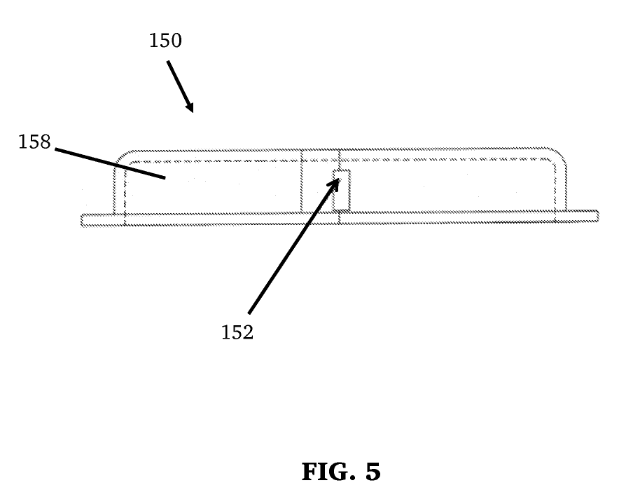

FIG. 5 is a side view of a safety cap assembly base 150 in accordance with exemplary embodiments. The base 150 may be substantially similar to the base 130 described with reference to FIGS. 3-4, with the exception of including a connector 152 and a single tier. In exemplary embodiments, a wall 158 of the base 150 may comprise at least one connector 152. It will be understood that at least one connector 152 can be any hinge and/or other connector capable of being coupled such that the base 150 can be placed about at least a portion of a coupler. For example, base 150 can include at least two, three, or four connectors 152, to name a few. Although the connector 152 is depicted on the base 150 in FIG. 5, one or more connectors 152 disposed on a top portion is also contemplated.

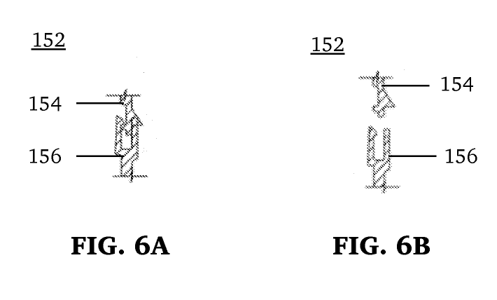

With reference to FIGS. 6A and 6B, an exemplary connector 152 is shown in both closed (FIG. 6A) and open (FIG. 6B) configurations. In exemplary embodiments, the connector portion 152 may comprise a male connector 154 and a female connector 156 adapted to join the connector portion 152, thereby allowing the base 150 to be disposed around at least a portion of a coupler. The male connector 154 may be adapted to fit within, and couple with, the female connector 156, securing the base 150 about at least a portion of the coupler.

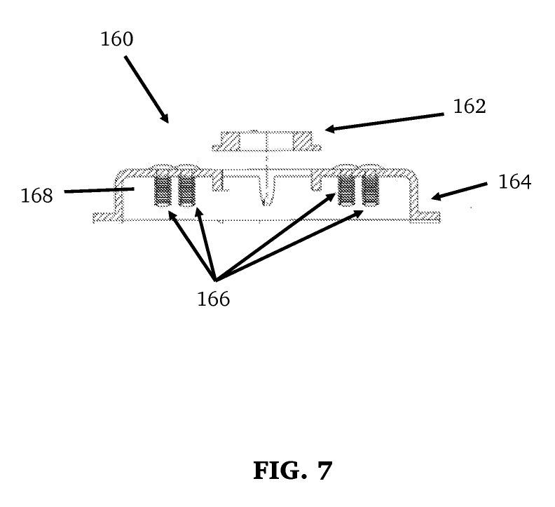

Referring now to FIG. 7, a cross-sectional view of a safety cap assembly 160 in accordance with exemplary embodiments is shown. In exemplary embodiments, the safety cap assembly 160 can comprise a cap 162, a base 164, and filler material 168 generally similar to those described with respect to FIGS. 3-4. In exemplary embodiments, the safety cap assembly 160 may also comprise geometric protrusions 166. In exemplary embodiments, the geometric protrusions 166 may comprise enhanced surface areas that may allow for increased surface such that when a safety cap assembly 160 is injected or otherwise at least partially filed with a filler material 168, then the filler material 168 can adhere to at least some of coupler, geometric protrusions 166, and a glass panel and/or film. It will be understood that geometric protrusions 166 can be any shape such as, but not limited to, squares, triangles, lozenges, herringbone, spiral shaped, and/or any other shape. For ease, geometric protrusions 166 are illustrated and/or described as being grooved spiral shaped. This is merely for ease and is in no way meant to be a limitation. Further, the spiral shape, as illustrated, can be formed by using a screw and/or any other grooved spiral shaped structure that increases the surface area for adhesion with filler material 168. In exemplary embodiments, the geometric protrusions 166 may be integral with a portion of the cover 162 and/or base 164, and/or the geometric protrusions 166 may comprise separate elements to be inserted into the cavity 146 through the cover 162 and/or the base 164. For example, the cover 162 and/or the base 164 may comprise additional apertures adapted to receive the geometric protrusions 166. In exemplary embodiments, the geometric protrusions 166 may also be adapted to pierce the surface of the cover 162 and/or the base and enter the channel.

In exemplary embodiments, safety cap assemblies 100, 150, 160 and/or geometric protrusions 166 can be constructed of any reasonable material such as, but not limited to, any plastic, polyethylene, polyester, aramid, para-aramid, acrylic, nylon, olefin, polyolefin, ultra-high-molecular-weight polyethylene (UHMWPE), high-modulus polyethylene (HMPE), high-performance polyethylene (HPPE), silicon carbide ceramic, thermoset liquid crystalline polyoxazole, lurex, wool, silk, cotton, flax, jute, hemp, modal, bamboo, asbestos, basalt, glass, any combination or further separation thereof, and/or from any material from an animal source, plant source, mineral source, and synthetic source, and/or any other reasonable source and/or limited to any metal and/or alloy such as, but not limited to, aluminum, iron, steel, stainless steel, carbon steel, titanium, iron, copper, zinc, and nickel, to name a few; any plastic material such as, but not limited to, thermoplastics, thermosetting polymers, polyethylene thermoplastics, High-density polyethylene (HDPE), Low-density polyethylene (LDPE), Ultra-high-molecular-weight polyethylene (UHMWPE), Nylon, Rubber, Polypropylene (PP), Polystyrene (PS), High impact polystyrene (HIPS), Acrylonitrile butadiene styrene (ABS), Polyethylene terephthalate (PET), and Polyvinyl chloride (PVC), to name a few; any ceramic such as, but not limited to, alumina and boron carbide, to name a few; any combination and separation thereof; and/or any other material adapted to contain a filler material 116, 168 and/or at least a portion of a coupler.

Safety cap assemblies 100, 150, 160 and/or geometric protrusions 166 can be constructed to be compliant with governmental safety requirements, such as, but not limited to, U.S. General Services Administrations compliancy, British Standards Institution, American National Standards Institute, European Committee for Standardization, and Consumer Product Safety Commission (CPSC), to name a few.

Further, the shape and/or external surface of safety cap assemblies 100, 150, 160 can be constructed to enhance the ornamental features of a point fix glass structures.

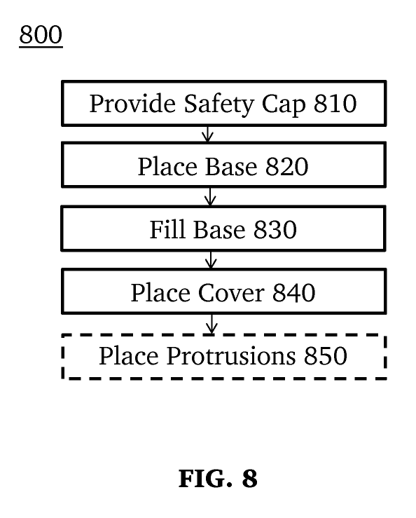

Referring now to FIG. 8, a block flow diagram illustrating an exemplary flow 800 for securing a coupler 104 for a point glass structure in accordance with exemplary embodiments is shown. For ease, the flow 800 is described with reference to the safety cap assembly 100 of FIGS. 1-7. The flow 800, however, may be carried out using other embodiments as well.

In exemplary embodiments, the flow 800 may begin with step 810. At step 810, in exemplary embodiments, a safety cap 100 may be provided. The safety cap 100 may be a size adapted to secure a coupler 104 to a glass panel 102 and/or film 106, and may comprise a cover 120 and/or a base 130 that may be pre-cut long a cut area 110, or any other area adapted to allow the cover 130 and/or the base 130 to fit around a portion of the coupler 104. Alternatively, in exemplary embodiments, the cover 120 and/or the base 130 may comprise one or more a hinges and or connector portions 150 as described with respect to FIGS. 5-6B instead of or in addition to the cut areas 110. For example, the cover 120 and/or the base 130 may comprise two hinges and/or connector portions 150 disposed on opposite sides of the cover 120 and/or base 130, respectively.

At step 820, in exemplary embodiments, the base 130 may be placed about a portion of the coupler 104. In exemplary embodiments, a first portion 112 of the coupler 104 may be inserted into the channel 146 through the cut area 110 of the base 130. In exemplary embodiments, when the base 130 is be placed about the first portion 112 of the coupler 104, the bottom edge portion 134 of the base may be placed substantially in contact with the glass panel 102 and/or film 106. In exemplary embodiments, the bottom edge portion 134 may be secured in place on the surface of the glass panel 102 and/or film 106 with the use of a binding material, for example, an adhesive. Alternatively, binding material may not be used to secure the bottom edge portion 134 in place on the surface of the glass panel 102 and/or film 106. In exemplary embodiments, when the bottom edge portion 134 of the base 130 is in contact with a glass panel 102, the channel 146 and at least a portion of the coupler 104 may be substantially enclosed within the inside surface of the wall 138 of the base 130 and the surface of the glass panel 140, with the top aperture 142 substantially open around the first portion 112 of the coupler 104.

At step 830, in exemplary embodiments the base 130 may be filled with filler material 116. The filler material 16 may be injected into the base 130 or otherwise placed in the base 130, substantially filling the portion of the channel 146 remaining that is not taken up by the portion of the coupler 104. In exemplary embodiments, the filler material 116 may be placed in the channel 146 through the top aperture 142 of the base, another aperture in the side wall, and/or through the bottom aperture 144. When inserted into the channel 146, the filler material 116 may be in direct physical contact with at least a portion of the internal surface of the base 130, the glass panel 102, and/or film 106, and at least a portion of the coupler 104. After insertion, the filler material 118 may harden, and may secure at least a portion of the coupler 104 to the glass panel 102 in the event of a failure of the glass panel 102. The filler material 118 may also be inserted after the cover 120 is placed about at least a portion of the coupler 104, and may be inserted through the aperture 124 in the top surface 122 of the cover 120. In exemplary embodiments, the filler material 116 may substantially harden and/or dry either before or after the cover 120 is placed.

At step 840, the cover 120 may be placed about at least a portion of the coupler 104. In exemplary embodiments, a second portion 114 of the coupler 104 may be inserted through the cut area 110 and/or connector portion 152 of the cover 120 into the aperture 124. In exemplary embodiments, a bottom portion of the cover 120 may be placed substantially in contact with the top edge portion 132 of the base 130. In exemplary embodiments, the bottom portion 128 of the cover 120 may be secured in place to the base 130 with or without the use of a binding material, for example, an adhesive. In exemplary embodiments, a binding material, such as an adhesive, may be placed on at least a portion of the top edge portion 132 of the base 130, such that when the bottom portion 128 of the cover 120 comes into contact with the adhesive, and the adhesive hardens or dries, the cover 120 may be attached to the base 130. In exemplary embodiments, when the bottom portion 128 of the cover 120 is in contact with at least a the top edge portion 132 of the base 130, the channel 146, at least a portion of the coupler 104, and/or the filler material 116 may be substantially enclosed within an interior surface of the top surface 122, the inside surface of the wall 138 of the base 130, and the surface of the glass panel 140 and/or the film 106, thereby providing support to the coupler 104.

At optional step 850, in exemplary embodiments, geometric protrusions 166 may be placed into the cavity. In exemplary embodiments, the geometric protrusions 166 may be placed before and/or after the filler material 116 is inserted. In exemplary embodiments, the geometric protrusions may be placed through the surface of the cover 120 and/or the base 130, or the geometric protrusions 166 may be placed through pre-formed apertures in the cover 120 and/or the base. When geometric protrusions 166 are placed, the filler material 116 may be in contact with at least a portion of the interior surface of the top surface 122, the inside surface of the wall 138 of the base 130, at least a portion of the coupler 104, the geometric protrusions 166, and/or the glass panel 102 and/or film 106.

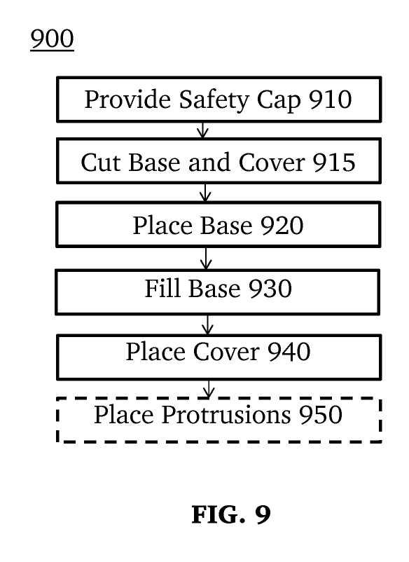

Referring now to FIG. 9, a block flow diagram illustrating an exemplary flow 900 for securing a coupler 104 for a point glass structure in accordance with exemplary embodiments is shown. For ease, the flow 900 is described with reference to the safety cap assembly 100 of FIGS. 1-7. The flow 900, however, may be carried out using other embodiments as well. In exemplary embodiments, steps 920, 930, 940, and 950 may be similar to those described supra with respect steps 820, 830, 840, and 850 of FIG. 8, respectively. At step 910, in exemplary embodiments, the safety cap assembly 100 may be provided with a cover 120 and/or base 130 that may not be pre-cut. By way of example, the cover 120 may comprise a single uncut unit and/or the base 130 may comprise a single uncut unit. In exemplary embodiments, the cover 120 and/or base 130 may comprise a weakened, scored, and/or perforated portion.

In exemplary embodiments, at step 915, the cover 120 and/or base 130 may be cut, using a cutting technique, along a cut area 110. In exemplary embodiments, the cut area 110 may be disposed between an outer perimeter of the top surface 122 and the aperture 124 formed in the cover 120, and/or on the wall 138 between the top edge portion 132 and the bottom edge portion 134 of the base 130. The use of any standard cutting technique, such as using a cutting device or cutting by force, is contemplated by and within the exemplary embodiments. In exemplary embodiments, a cut may be made along the cut area 110 in a straight line or in any shape, such as a curved, angled, and/or jagged line. If the cover 130 and/or base 120 comprise a perforated portion, the cutting step may include tearing the perforated portion to allow the cover 120 and/or base 130 to be placed on a portion of the coupler 104. After the cover 120 and/or base 130 are cut, the flow 900 may follow similar steps to those described in FIG. 8, starting at step 820.

Now that exemplary embodiments of the present disclosure have been shown and described in detail, various modifications and improvements therein will become readily apparent to those skilled in the art.

It will be understood that one or more of the steps described can be rearranged, separated, and/or combined without deviating from the scope of embodiments of the disclosure. For ease, steps are, at times, presented sequentially. This is merely for ease and is in no way meant to be a limitation.

Further, it will be understood that one or more of the elements and/or exemplary embodiments of the disclosure described can be rearranged, separated, and/or combined without deviated from the scope of the disclosure. For ease, various elements are described, at times, separately. This is merely for ease and is in no way meant to be a limitation.

While the various steps, elements, and/or exemplary embodiments of the disclosure have been outlined above, it is evident that many alternatives, modifications and variations will be apparent to those skilled in the art. The various steps, elements, and/or exemplary embodiments of the disclosure, as set forth above, are intended to be illustrative, not limiting. Various changes can be made without departing from the spirit and scope of the disclosure. Accordingly, the spirit and scope of the present disclosure is to be construed broadly and not limited by the foregoing specification.

No element, act, or instruction used in the description of the present application should be construed as critical or essential to the disclosure unless explicitly described as such. Also, as used herein, the article “a” is intended to include one or more items. Where only one item is intended, the term “one” or similar language is used.

Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. In addition, as used herein, the term “set” is intended to include any number of items, including zero. Further, as used herein, the term “number” is intended to include any number, including zero.

What is claimed:

1. A safety cap assembly for use with a coupler for a point glass structure comprising:
a base comprising:
a top edge portion defining a top aperture;
a bottom edge portion defining a bottom aperture;
a wall extending from the top edge portion to the bottom edge portion;
a channel extending from the top aperture to the bottom aperture, the channel adapted to receive at least a first portion of the coupler and to receive filler material that provides support to the point glass structure; and
a cover disposed on the top edge portion of the base, the cover comprising a top surface having an aperture formed therein adapted to receive at least a second portion of the coupler.

2. The safety cap assembly of claim 1, wherein the top surface comprises an outer perimeter larger than the outer perimeter of the top aperture of the base.

3. The safety cap assembly of claim 1, wherein the aperture of the cover is smaller than the top aperture of the base.

4. The safety cap assembly of claim 1, wherein the bottom aperture of the base is larger than the top aperture of the base.

5. The safety cap assembly of claim 1, wherein the base comprises at least one tiered edge formed in the wall substantially between the top edge portion and the bottom edge portion.

6. The safety cap assembly of claim 1, wherein at least one of the cover and the base are ring-shaped.

7. The safety cap assembly of claim 1, wherein the cover further comprises a lip extending perpendicularly from the top surface adjacent the perimeter of the top surface, the lip adapted to fit over the wall adjacent the top edge portion of the base.

8. The safety cap assembly of claim 1, wherein at least one of the cover and the base comprise a material adapted to be cut.

9. The safety cap assembly of claim 1, wherein the base comprises a cut area extending from the bottom edge portion to the top edge portion, the cut area adapted to allow the base to be placed about the first portion of the coupler.

10. The safety cap assembly of claim 1, wherein the cover comprises a cut area extending from an outer edge of the top surface to the aperture adapted to allow the cover to be placed about the second portion of the coupler.

11. The safety cap assembly of claim 1, wherein the base comprises a perforated portion extending from the bottom edge portion to the top edge portion; and
wherein the perforated portion is adapted to be torn, thereby allowing the base to be placed around the first portion of the coupler.

12. The safety cap assembly of claim 1, wherein the cover comprises a perforated portion extending from an outer edge of the top surface to the aperture; and
wherein the perforated portion is adapted to be torn, thereby allowing the cover to be placed around the second portion of the coupler.

13. The safety cap assembly of claim 1, further comprising one or more geometric protrusions extending through the top surface of the cover into the channel.

14. The safety cap assembly of claim 13, wherein each of the one or more geometric protrusions is a screw.

15. The safety cap assembly of claim 1, wherein the wall comprises a hinged portion and connector portion, wherein the connector portion comprises a male connector and a female connector adapted to releasably attach; and
wherein the hinged portion is adapted to allow at least two portions of the base to hinge about the hinged portion when the connector portion is unattached, thereby allowing the base to be placed around the first portion of the coupler and attached around the first portion with the connector portion.

16. The safety cap assembly of claim 1, wherein the cover and the base are opaque.

17. The safety cap assembly of claim 1, wherein the cover and the base are translucent.

18. A safety cap assembly for use with a coupler for a point glass structure comprising:
a base comprising:
a top edge portion defining a top aperture;
a bottom edge portion defining a bottom aperture;
a wall extending from the top edge portion to the bottom edge portion;
a channel extending from the top aperture to the bottom aperture, the channel adapted to receive at least a first portion of the coupler;
a filler material disposed inside the channel; and
a cover disposed on the top edge portion of the base, the cover comprising a top surface having an aperture formed therein adapted to receive at least a second portion of the coupler.

19. The safety cap assembly of claim 18, wherein the bottom edge portion of the base is in contact with at least a portion of a glass panel.

20. The safety cap assembly of claim 18, wherein the bottom edge portion of the base is in contact with a film coating a surface of at least a portion of a glass panel.

21. The safety cap assembly of claim 18, wherein the filler material comprises at least one of an epoxy or a resin.

22. The safety cap assembly of claim 18, wherein the first portion of the coupler is disposed within the channel;
wherein the second portion of the coupler is disposed within the aperture of the cover; and
wherein filler material is in contact with an inner surface of the cover, an inner surface of the base, an outer surface of the first portion of the coupler, and at least a portion of a glass panel.

23. The safety cap assembly of claim 18, wherein the first portion of the coupler is disposed within the channel;
wherein the second portion of the coupler is disposed within the aperture of the cover; and
wherein the filler material is in contact with an inner surface of the cover, an inner surface of the base, an outer surface of the first portion of the coupler, and a film coating the surface of at least a portion of a glass panel.

24. The safety cap assembly of claim 18, further comprising one or more geometric protrusions extending through the top surface of the cover into the channel.

25. The safety cap assembly of claim 18, wherein each of the one or more geometric protrusions is a screw.

26. The safety cap assembly of claim 18, wherein the wall comprises a hinged portion and connector portion, wherein the connector portion comprises a male connector and a female connector adapted to releasably attach; and
wherein the hinged portion is adapted to allow at least two portions of the base to hinge about the hinged portion when the connector portion is unattached, thereby allowing the base to be placed around the first portion of the coupler and attached around the first portion with the connector portion.

27. A method of securing a coupler for a point glass structure comprising:
providing a safety cap assembly comprising:
a base comprising:
a top edge portion defining a top aperture;
a bottom edge portion defining a bottom aperture;
a wall extending from the top edge portion to the bottom edge portion;
a channel extending from the top aperture to the bottom aperture, the channel adapted to receive at least a first portion of the coupler; and
a cover comprising a top surface having an aperture formed therein adapted to receive at least a second portion of the coupler;
placing the base about the first portion of the coupler;
attaching the bottom edge portion to at least a portion of a glass panel;
substantially filling the channel with a filler;
placing the cover about the second portion of the coupler; and
attaching the cover to the top edge portion of the base.

28. A method of securing a coupler for a point glass structure comprising:
providing a safety cap assembly comprising:
a base comprising:
a top edge portion defining a top aperture;
a bottom edge portion defining a bottom aperture;
a wall extending from the top edge portion to the bottom edge portion;
a channel extending from the top aperture to the bottom aperture, the channel adapted to receive at least a first portion of the coupler;
at least one of a cut, weakened, or perforated portion extending from the top edge portion to the bottom edge portion on the wall; and
a cover comprising:
a top surface having an aperture formed therein adapted to receive at least a second portion of the coupler; and
at least one of a cut, weakened, or perforated portion extending from an outer surface of the top surface to the aperture formed therein;
placing the base about the first portion of the coupler;
attaching the bottom edge portion to at least a portion of a glass panel;
substantially filling the channel with a filler;
placing the cover about the second portion of the coupler; and
attaching the cover to the top edge portion of the base.
